(19) United States
(12) Patent Application Publication
(10) Pub. No.: US 2024/0089801 A1
(43) Pub. Date: Mar. 14, 2024

(54) APPLICATION FUNCTION SESSION PROCESSING METHOD, APPARATUS AND STORAGE MEDIUM

(71) Applicant: BEIJING XIAOMI MOBILE SOFTWARE CO., LTD., Beijing (CN)

(72) Inventors: Dong CHEN, Beijing (CN); Lei YU, Beijing (CN)

(73) Assignee: BEIJING XIAOMI MOBILE SOFTWARE CO., LTD., Beijing (CN)

(21) Appl. No.: 18/274,438

(22) PCT Filed: Jan. 26, 2021
(86) PCT No.: PCT/CN2021/073849

§ 371 Date: Jul. 26, 2023

(51) Int. Cl. H04W 28/24

(52) U.S. Cl. CPC H04W 28/24

(57) ABSTRACT

An application function (AF) session processing method is applied to a first network device and includes: sending an update request for quality of service (QoS) of an AF session. The update request for the QoS of the AF session includes parameter information of a group of terminals, and the group of terminals includes one or more terminals.

### CROSS-REFERENCE TO RELATED APPLICATION

This application is the U.S. national phase application of International Application No. PCT/CN2021/073849, filed on Jan. 26, 2021, the disclosure of which is incorporated herein by reference in its entirety for all purposes.

### BACKGROUND

As the development of artificial intelligence (AI), multi-modal interaction and multi-modal machine learning have become important research fields. In multi-modal technologies, multi-modal information is to be fused and processed for obtaining better interactive experiences.

In related arts, during processing multi-modal data, each of a plurality of modalities may be taken as one application, and a plurality of protocol data unit (PDU) sessions corresponding to the plurality of modalities are coordinated and processed in an application layer (AL). During processing the multi-modal data in the AL, it is expected to dynamically adjust a quality of service (QoS) requirement of each modality based on network conditions and a QoS requirement coordination of the plurality of applications. The QoS requirements of the multi-modal data may not be met in a scenario where the AL has no function of performing the dynamical adjustment, and may have to be achieved through interacting with the 3rd generation partnership project (3GPP) network. However, it is possible that the 3GPP network cannot meet the QoS requirements of the multi-modal data in an actual situation of the network.

### SUMMARY

The present disclosure relates to the field of wireless communication technologies, and in particular to an application function (AF) session processing method, an AF session processing apparatus, and a storage medium.

According to a first aspect of the present disclosure, an AF session processing method is provided. The AF session processing method is applied to a first network device and includes: sending an update request for quality of service (QoS) of an AF session, wherein the update request for the QoS of the AF session includes parameter information of a group of terminals, and the group of terminals includes one or more terminals.

According to a second aspect of the present disclosure, an AF session processing method is provided. The AF session processing method is applied to a second network device and includes: obtaining a first update request for QoS of an AF session, wherein the first update request for the QoS of the AF session includes parameter information of a group of terminals, and the group of terminals includes one or more terminals.

According to a third aspect of the present disclosure, an AF session processing method is provided. The AF session processing method is applied to a third network device and includes: obtaining an update request for application policy authorization, wherein the update request for application policy authorization includes parameter information of a group of terminals, and the group of terminals includes one or more terminals.

It should be understood that the above general description and the following detailed description are only illustrative and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 illustrates an architecture diagram of a communication system between a network device and terminals according to an example of the present disclosure.

FIG. 2 illustrates a flowchart of an AF session processing method according to an example of the present disclosure.

FIG. 3 illustrates a flowchart of another AF session processing method according to an example of the present disclosure.

FIG. 4 illustrates a flowchart of another AF session processing method according to an example of the present disclosure.

FIG. 5 illustrates a flowchart of another AF session processing method according to an example of the present disclosure.

FIG. 6 illustrates a flowchart of another AF session processing method according to an example of the present disclosure.

FIG. 7 illustrates a flowchart of another AF session processing method according to an example of the present disclosure.

FIG. 8 illustrates a flowchart of another AF session processing method according to an example of the present disclosure.

FIG. 9 illustrates a flowchart of another AF session processing method according to an example of the present disclosure.

FIG. 10 illustrates a flowchart of another AF session processing method according to an example of the present disclosure.

FIG. 11 illustrates an interaction diagram of an AF session processing method according to an example of the present disclosure.

FIG. 12 illustrates a block diagram of an AF session processing apparatus according to an example of the present disclosure.

FIG. 13 illustrates a block diagram of another AF session processing apparatus according to an example of the present disclosure.

FIG. 14 illustrates a block diagram of another AF session processing apparatus according to an example of the present disclosure.

FIG. 15 illustrates a block diagram of an apparatus for AF session processing according to an example of the present disclosure.

FIG. 16 illustrates a block diagram of another apparatus for AF session processing according to an example of the present disclosure.

### DETAILED DESCRIPTION OF THE EMBODIMENTS

Embodiments will be described in detail here with the examples thereof illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

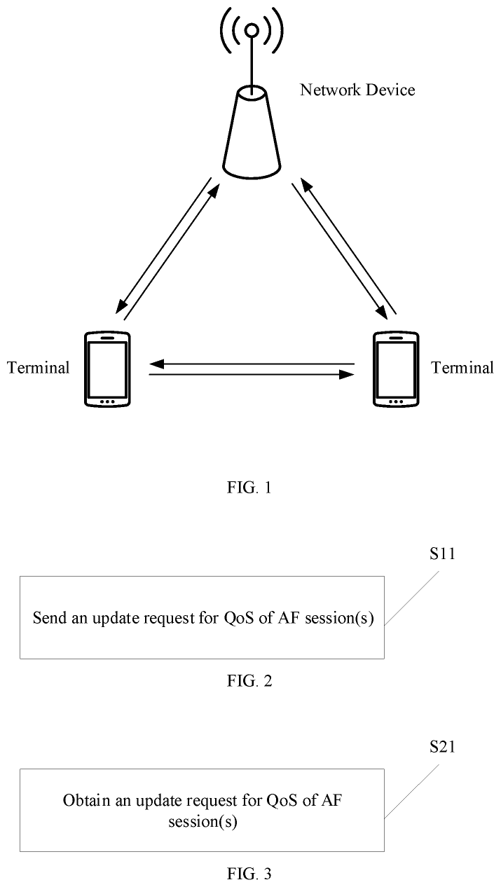

FIG. 1 illustrates an architecture diagram of a communication system between a network device and terminals according to an example. The communication methods provided by the present disclosure may be applied to the architecture diagram of the communication system illustrated in FIG. 1. As illustrated in FIG. 1, the network-side device may send signaling under the architecture illustrated in FIG. 1.

It can be understood that the communication system between the network device and the terminals, as illustrated in FIG. 1, is only a schematic illustration. The wireless communication system may further include other network devices, such as core network devices, wireless relay devices, wireless backhaul devices, etc., which are not illustrated in FIG. 1. The example of the present disclosure has no limits for the number of the network devices and the number of terminals included in the wireless communication system.

It can be further understood that the wireless communication system in the example of the present disclosure is a network that provides a wireless communication function. The wireless communication system may adopt different communication technologies, such as code division multiple access (CDMA), wideband code division multiple access (WCDMA), time division multiple access (TDMA), frequency division multiple access FDMA), orthogonal frequency division multiple access (OFDMA), single carrier frequency division multiple access (SC-FDMA), and carrier sense multiple access with collision avoidance. According to some factors such as capacity, speed and delay in different networks, a network may be classed into a 2nd generation (2G) network, a 3G network, a 4G network or a future evolution network, such as a 5G network that is also called a new radio (NR) network. For convenience of description, the present disclosure sometimes refers to the wireless communication network as “network” for short.

Furthermore, the network device involved in the present disclosure may also be referred to as a radio access network device. The wireless access network device may be a base station, an evolved node B, a femtocell, an access point (AP) in a wireless fidelity (WiFi) system, a wireless relay node, a wireless backhaul node, a transmission point (TP) or a transmission and reception point (TRP), etc., or may be a gNB in an NR system. Alternatively, the wireless access device may be a device that constitutes a component or a part of the base station. In a vehicle-to-everything (V2X) communication system, the network device may be an in-vehicle device. It can be understood that, the example of the present disclosure has no limits for the specific technology and the specific device form of the network device.

Furthermore, the terminal involved in the present disclosure, as a device that provides voice and/or data connectivity for a user, may also be referred to as terminal equipment, user equipment (UE), a mobile station (MS), a mobile terminal (MT), etc. For example, the terminal may be a handheld device, a vehicle-mounted device, or the like which is equipped with a wireless connection function. At present, some examples of the terminal include a mobile phone, a pocket personal computer (PPC), a handheld computer, a personal digital assistant (PDA), a notebook computer, a tablet computer, a wearable device, an in-vehicle device, or the like. In addition, in a V2X communication system, the terminal device may be an in-vehicle device. It can be understood that, the example of the present disclosure has no limits for the specific technology and the specific device form of the terminal.

As artificial intelligence (AI) technologies develop rapidly, multi-modal interaction and multi-modal machine learning have become important research fields. In multi-modal technologies, multi-modal information is to be fused and processed for obtaining better interactive experiences and stronger machine learning capabilities. Each of these specific types of information or representations in which the information is stored may be referred to as a modality. For example, touch, hearing, sight, smell, and the like of human being. Multimedia data for describing the same object is a medium for the same type of data information from different sensors. In a broad sense, two kinds of different languages may be taken as two modalities, and even data sets collected in two different situations may be regarded as two modalities.

In related arts, the network defined by the 3rd generation partnership project (3GPP) processes the multi-modal information as application layer data, and the coordination between modalities is processed by the application layer.

Therefore, during processing the multi-modal data in the related arts, the application layer is expected to coordinate quality of service (QoS) requirements of various applications according to network conditions, so as to dynamically adjust the QoS requirement of each modality. Not all application layers are provided with such capability. The QoS requirements of the multi-modal data may not be met in a scenario where the application layer has no function of performing the dynamical adjustment, and may have to be achieved through interacting with the 3GPP network. However, it is possible that the 3GPP network cannot meet the QoS requirements of the multi-modal data in an actual situation of the network.

In view of the above, the present disclosure provides an application function (AF) session processing method, in which an AF sends multi-modal QoS update requests of all terminals together to the network. All terminals means one group of terminals, or multiple groups of terminals. It can be understood that one group of terminals includes a plurality of terminals.

In other words, the AF sends the multi-modal QoS update requests of all the terminals to a policy control function (PCF) through a network exposure function (NEF), and the PCF performs unified policy control based on the QoS update requests of all the terminals.

FIG. 2 illustrates a flowchart of an AF session processing method according to an example. As illustrated in FIG. 2, the AF session processing method is applied in a first network device and includes the following steps.

At step S11, an update request for QoS of AF session(s) (e.g., Nnef_AFsessionWithQoS_Update request) is sent.

In the example of the present disclosure, the update request for the QoS of AF session(s) includes parameter information of a group of terminals. The group of terminals includes one or more terminals. The first network device may be a network element or a node. In the example of the present disclosure, the first network device may be regarded as the AF.

In an example of the present disclosure, the AF has established AF sessions with a group of terminals that have required QoSs. The AF determines to send the update request for the QoS of AF session(s) to a second network device (e.g., NEF) for reserving resources to update the QoSs.

In one or more examples of the present disclosure, the parameter information of the group of terminals includes at least one of:

AF Identifier;

Transaction Reference Identity (ID);

Flow description(s) mapped to the group of terminals;

QoS reference mapped to the group of terminals; or

Alternative Service Requirements.

In one or more examples of the present disclosure, the update request for the QoS of AF session(s) may also include a request time period and/or a request traffic volume that is mapped to the group of terminals. It is determined that the transaction reference ID included in the update request for the QoS of AF session(s) is set as a reference ID which is assigned by the NEF for creating the update request for the QoS of AF session(s).

Based on the same/similar conception, the examples of the present disclosure also provide an AF session processing method.

FIG. 3 illustrates a flowchart of an AF session processing method according to an example. As illustrated in FIG. 3, the AF session processing method is applied in a second network device and includes the following step.

At step S21, an update request for QoS of AF session(s) is obtained.

In the example of the present disclosure, the update request for the QoS of AF session(s) includes parameter information of a group of terminals. The group of terminals includes one or more terminals.

In the example of the present disclosure, the second network device may be a network element or a node. In the example of the present disclosure, the second network device may be regarded as a NEF.

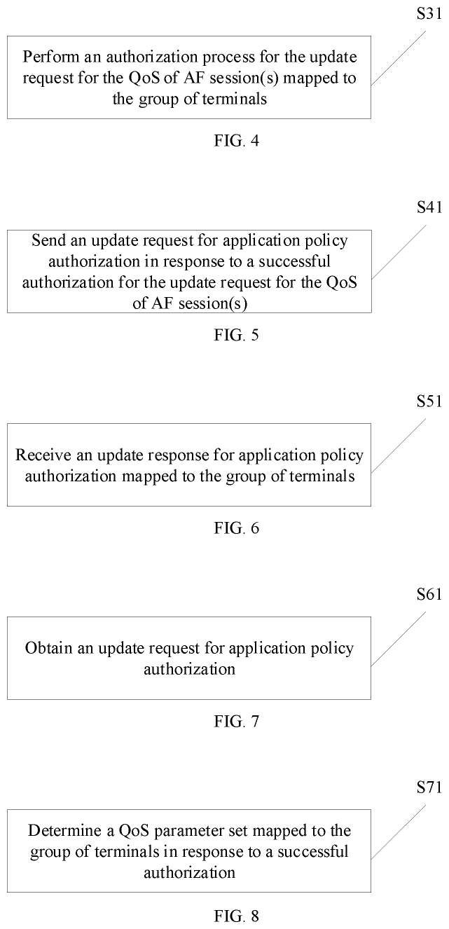

FIG. 4 illustrates a flowchart of an AF session processing method according to an example. As illustrated in FIG. 4, the AF session processing method is applied in the second network device and includes the following step.

At step S31, an authorization process is performed for the update request for the QoS of AF session(s) mapped to the group of terminals.

In the example of the present disclosure, the NEF (e.g., a network operator) performs the authorization process for the received update request for the QoS of AF session(s), and may apply a policy to control the authorization for the update request for the QoS of AF session(s), and authorize an overall amount of pre-defined QoS mapped to the group of terminals to the AF.

FIG. 5 illustrates a flowchart of an AF session processing method according to an example. As illustrated in FIG. 5, the AF session processing method is applied in the second network device and includes the following step.

At step S41, an update request for application policy authorization (e.g., Npcf_PolicyAuthorization_Update request) is sent in response to a successful authorization for the update request for the QoS of AF session(s).

In the example of the present disclosure, the update request for application policy authorization includes parameter information of the group of terminals.

In one implementation, in the case where the NEF successfully authorizes the update request for the QoS of AF session(s), the NEF sends the update request for application policy authorization to a third network device (e.g., a PCF), and provides the PCF with the parameter information of the group of terminals through interacting between the NEF and the PCF. The update request for application policy authorization also includes any optional received item like a time period and/or a traffic volume, which is mapped to connectivity information of the group of terminals.

In one implementation, in the case where the NEF failed to authorize the update request for the QoS of AF session(s), the NEF sends a value corresponding to the result of authorization failure to the AF. The AF is informed through the value corresponding to the result of authorization failure that the update request for the QoS of AF session(s) has not been granted.

In one or more examples of the present disclosure, the parameter information of the group of terminals includes at least one of:

AF Identifier;

Transaction Reference ID;

Flow description(s) mapped to the group of terminals;

QoS reference mapped to the group of terminals; or

Alternative Service Requirements.

FIG. 6 illustrates a flowchart of an AF session processing method according to an example. As illustrated in FIG. 6, the AF session processing method is applied in the second network device and includes the following step.

At step S51, an update response for application policy authorization (e.g., Npcf_PolicyAuthorization_Update response) mapped to the group of terminals is received.

In the example of the present disclosure, after the NEF sends the update request for application policy authorization to the PCF in response to the successful grant for the received update request for the QoS of AF session(s), it is determined to receive the update response for application policy authorization mapped to the group of terminals which is sent by the PCF. The update response for application policy authorization also includes indication information of allowing/disallowing a QoS parameter set, which is mapped to the group of terminals, to be updated. The update response for application policy authorization may also include an indication that the update of the QoS parameter set mapped to the group of terminals is successful/failed.

In one or more examples of the present disclosure, according to the received update response for application policy authorization mapped to the group of terminals, a QoS message for AF session(s) is sent to the AF. In the QoS message for AF session(s), the indication information of allowing/disallowing the QoS parameter set, which is mapped to the group of terminals, to be updated is sent, and/or, the indication that the update of the QoS parameter set mapped to the group of terminals is successful/failed may also be included.

Based on the same/similar conception, the examples of the present disclosure also provide an AF session processing method.

FIG. 7 illustrates a flowchart of an AF session processing method according to an example. As illustrated in FIG. 7, the AF session processing method is applied in a third network device and includes the following step.

At step S61, an update request for application policy authorization is obtained.

In the example of the present disclosure, the update request for application policy authorization includes parameter information of a group of terminals. The group of terminals includes one or more terminals.

The third network device may be a network element or a node. In the example of the present disclosure, the third network device may be regarded as a PCF.

FIG. 8 illustrates a flowchart of an AF session processing method according to an example. As illustrated in FIG. 8, the AF session processing method is applied in the third network device and includes the following step.

At step S71, a QoS parameter set mapped to the group of terminals is determined in response to a successful authorization.

In the example of the present disclosure, when receiving the update request for application policy authorization and determining that the NEF achieves the successful authorization, the PCF determines parameter information of the group of terminals expected for export based on the parameter information of the group of terminals included in the update request for application policy authorization, and then determines the QoS parameter set mapped to the group of terminals. Furthermore, the PCF determines whether to allow the determined QoS parameter set mapped to the group of terminals to be updated.

In one or more examples of the present disclosure, the update request for application policy authorization includes an alternative service request that includes one or more QoS reference parameter sets mapped to the group of terminals.

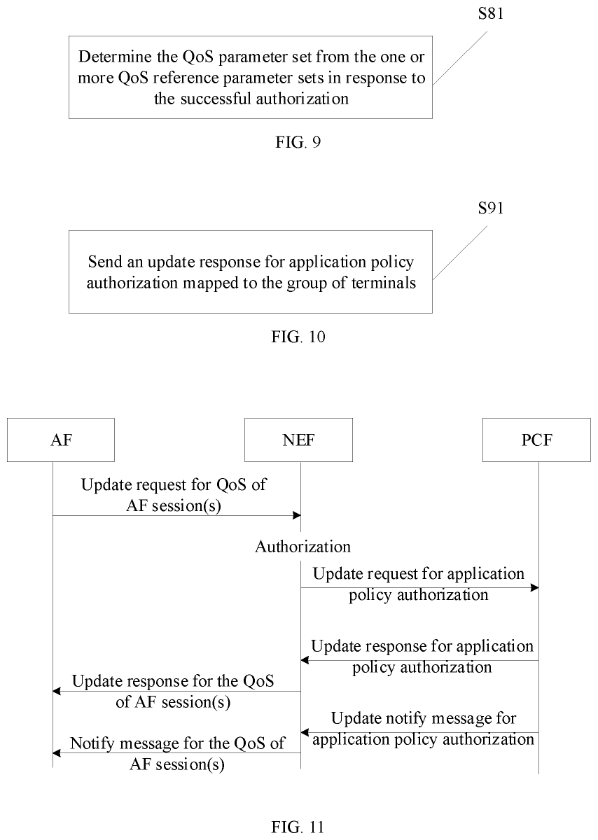

FIG. 9 illustrates a flowchart of an AF session processing method according to an example. As illustrated in FIG. 9, the AF session processing method is applied in the third network device and includes the following step.

At step S81, the QoS parameter set is determined from the one or more QoS reference parameter sets in response to the successful authorization.

In some examples of the present disclosure, when determining that the QoS parameter set mapped to the group of terminals is allowed to be updated and determining that the QoS parameter set mapped to the group of terminals includes one or more alternative service requirements, the PCF determines alternative QoS parameters and determines, in accordance with a predefined priority order, one or more QoS reference parameter sets from the alternative QoS parameters which are taken as candidates.

In another implementation, the PCF determines that the QoS parameter set mapped to the group of terminals is disallowed to be updated, and determines a value corresponding to the result indicating the reason for not being granted or allowed.

FIG. 10 illustrates a flowchart of an AF session processing method according to an example. As illustrated in FIG. 10, the AF session processing method is applied in the third network device and includes the following step.

At step S91, an update response for application policy authorization (e.g., Npcf_PolicyAuthorization_Update response) mapped to the group of terminals is sent.

In an implementation of an example of the present disclosure, the PCF determines that the parameter information of the group of terminals is allowed to be updated, and sends the update response for application policy authorization mapped to the group of terminals. The update response for application policy authorization includes indication information of allowing the QoS parameter set mapped to the group of terminals to be updated.

In one implementation, the PCF determines that the parameter information of the group of terminals is disallowed to be updated, and sends the update response for application policy authorization mapped to the group of terminals. The update response for application policy authorization includes indication information of disallowing the QoS parameter set mapped to the group of terminals to be updated.

In one or more examples of the present disclosure, the parameter information of the group of terminals includes at least one of:

AF Identifier;

Transaction Reference ID;

Flow description(s) mapped to the group of terminals;

QoS reference mapped to the group of terminals; or

Alternative Service Requirements.

In one or more examples of the present disclosure, in response to that the QoS parameter set mapped to the group of terminals is updated successfully, an update notify message for application policy authorization (e.g, Npcf_PolicyAuthorization_Notify) is sent and instructs the NEF that the update of the QoS parameter set mapped to the group of terminals is successful.

In some examples of the present disclosure, in response to that the QoS parameter set mapped to the group of terminals is failed to be updated, an update notify message for application policy authorization is sent and instructs the NEF that the update of the QoS parameter set mapped to the group of terminals is failed.

In an example of the present disclosure, the AF session processing method is described by taking the interaction of the first network device (e.g., the AF), the second network device (e.g., the NEF), and the third network device (the PCF) as the example. FIG. 11 illustrates an interaction diagram of an AF session processing method according to an example. As illustrated in FIG. 11, the AF sends an update request for QoS of AF session(s), and the NEF performs the authorization process for the update request for the QoS of AF session(s) mapped to a group of terminals. In response to a successful authorization for the update request for the QoS of AF session(s), an update request for application policy authorization is sent to the PCF. In response to a failed authorization for the update request for the QoS of AF session(s), the NEF sends a value corresponding to the result of authorization failure to the AF. The AF is informed through the value corresponding to the result of authorization failure that the update request for the QoS of AF session(s) is not granted. In response to receiving the update request for application policy authorization and determining that the NEF achieves the successful authorization, the PCF determines parameter information of the group of terminals expected for export based on the parameter information of the group of terminals included in the update request for application policy authorization, and then determines the QoS parameter set mapped to the group of terminals. The PCF also determines whether to allow the determined QoS parameter set mapped to the group of terminals to be updated, and sends an update response for application policy authorization mapped to the group of terminals. The PCF also sends an update notify message for application policy authorization according to the successful update/identification of the QoS parameter set mapped to the group of terminals. According to the received update response for application policy authorization and the update notify message for application policy authorization, the NEF sends an update response for the QoS of AF session(s) and a notify message for the QoS of AF session(s) to the AF.

Based on the same/similar conception, the examples of the present disclosure also provide an AF session processing apparatus.

It can be understood that the AF session processing apparatus provided in the examples of the present disclosure includes hardware structures and/or software modules corresponding to the execution of each function in order to achieve the above functions. By combining with the units and the algorithm steps of each example disclosed by the present disclosure, the examples of the present disclosure can be implemented in the form of hardware or a combination of hardware and computer software. Whether a certain function is performed in hardware or in a way that the computer software drives the hardware depends on various specific applications and design constraints of the technical solution. Those skilled in the art may use different approaches to implement the described function for each specific application, which should not be considered beyond the scope of the technical solutions provided by the examples of the present disclosure.

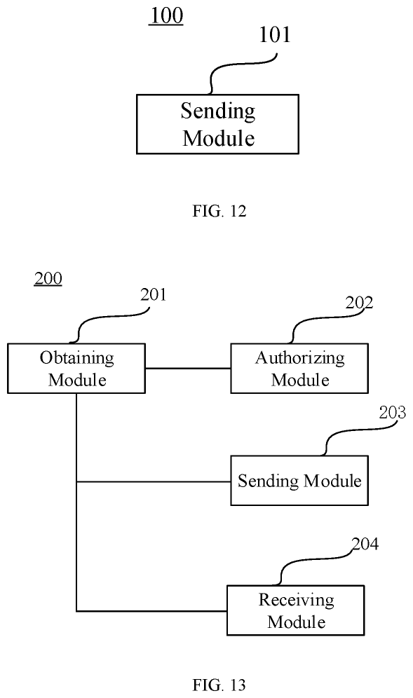

FIG. 12 illustrates a block diagram of an AF session processing apparatus according to an example. By referring to FIG. 12, the AF session processing apparatus 100 is applied to a first network device and includes a sending module 101.

The sending module 101 is configured to send an update request for QoS of AF session(s). The update request for the QoS of AF session(s) includes parameter information of a group of terminals. The group of terminals includes one or more terminals.

In one or more examples of the present disclosure, the parameter information of the group of terminals includes at least one of:

AF Identifier;

Transaction Reference ID;

Flow description(s) mapped to the group of terminals;

QoS reference mapped to the group of terminals; or

Alternative Service Requirements.

FIG. 13 illustrates a block diagram of an AF session processing apparatus according to an example. By referring to FIG. 13, the AF session processing apparatus 200 is applied to a second network device and includes an obtaining module 201.

The obtaining module 201 is configured to obtain an update request for QoS of AF session(s). The update request for the QoS of AF session(s) includes parameter information of a group of terminals. The group of terminals includes one or more terminals.

In one or more examples of the present disclosure, as illustrated in FIG. 13, the AF session processing apparatus further includes an authorizing module 202.

The authorizing module 202 is configured to perform an authorization process for the update request for the QoS of AF session(s) mapped to the group of terminals.

In one or more examples of the present disclosure, as illustrated in FIG. 13, the AF session processing apparatus further includes a sending module 203.

The sending module 203 is configured to send, in response to a successful authorization for the update request for the QoS of AF session(s), an update request for application policy authorization. The update request for application policy authorization includes the parameter information of the group of terminals.

In one or more examples of the present disclosure, as illustrated in FIG. 13, the AF session processing apparatus further includes a receiving module 204.

The receiving module 204 is configured to receive an update response for application policy authorization mapped to the group of terminals.

In one or more examples of the present disclosure, the parameter information of the group of terminals includes at least one of:

AF Identifier;

Transaction Reference ID;

Flow description(s) mapped to the group of terminals;

QoS reference mapped to the group of terminals; or

Alternative Service Requirements.

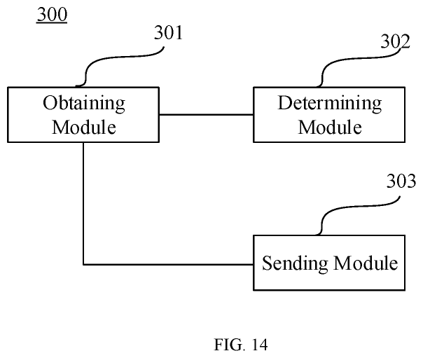

FIG. 14 illustrates a block diagram of an AF session processing apparatus according to an example. By referring to FIG. 14, the AF session processing apparatus 300 is applied to a third network device and includes an obtaining module 301.

The obtaining module 301 is configured to obtain an update request for application policy authorization. The update request for application policy authorization includes parameter information of a group of terminals. The group of terminals includes one or more terminals.

In one or more examples of the present disclosure, the AF session processing apparatus further includes a determining module 302.

The determining module 302 is configured to determine, in response to a successful authorization, a QoS parameter set mapped to the group of terminals.

In one or more examples of the present disclosure, the update request for application policy authorization includes an alternative service request that includes one or more QoS reference parameter sets mapped to the group of terminals.

In one or more examples of the present disclosure, the determining module 302 is further configured to:

determine, in response to the successful authorization, the QoS parameter set from the one or more QoS reference parameter sets.

In one or more examples of the present disclosure the AF session processing apparatus further includes a sending module 303.

The sending module 303 is configured to send an update response for application policy authorization mapped to the group of terminals.

In one or more examples of the present disclosure, the parameter information of the group of terminals includes at least one of:

AF Identifier;

Transaction Reference ID;

Flow description(s) mapped to the group of terminals;

QoS reference mapped to the group of terminals; or

Alternative Service Requirements.

With respect to the apparatus in the foregoing examples, the specific manner in which each module performs its operation has been described in detail in the examples of the related methods, and will not be further elaborated here.

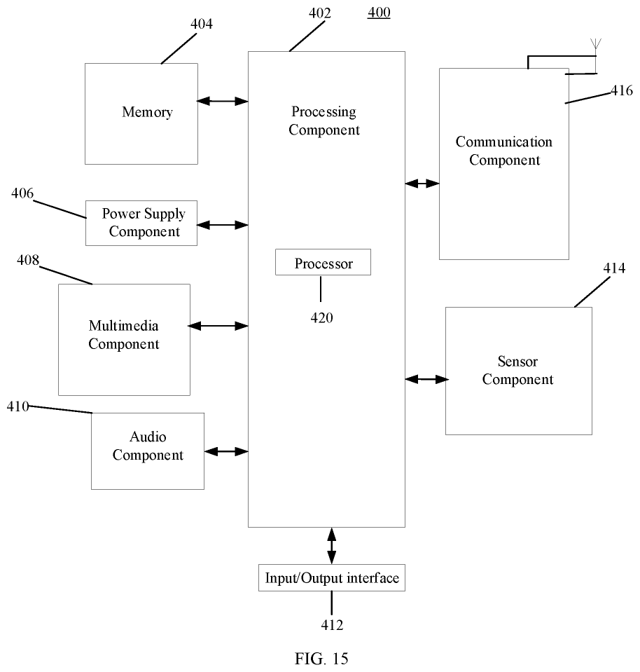

FIG. 15 illustrates a block diagram of an apparatus for AF session processing according to an example. For example, the apparatus 400 may be a network device.

By referring to FIG. 15, the apparatus 400 may include one or more of the following components: a processing component 402, a memory 404, a power supply component 406, a multimedia component 408, an audio component 410, an input/output (I/O) interface 412, a sensor component 414, and a communication component 416.

The processing component 402 generally controls the overall operations of the apparatus 400, such as operations associated with display, phone calls, data communications, camera operations, and recording operations. The processing component 402 may include one or more processors 420 to execute instructions to complete all or a part of the steps of the above methods. In addition, the processing component 402 may include one or more modules which facilitate the interaction between the processing component 402 and other components. For example, the processing component 402 may include a multimedia module to facilitate the interaction between the multimedia component 408 and the processing component 402.

The memory 404 is configured to store various types of data to support the operations of the apparatus 400. Examples of such data include instructions for any application or method operated on the apparatus 400, contact data, phonebook data, messages, pictures, videos, and the like. The memory 404 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The power supply component 406 provides power for various components of the apparatus 400. The power supply component 406 may include a power management system, one or more power supplies, and other components associated with generating, managing, and distributing power for the apparatus 400.

The multimedia component 408 includes a screen providing an output interface between the apparatus 400 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a lasting time and a pressure associated with the touch or swipe. In some examples, the multimedia component 408 includes a front camera and/or a rear camera. The front camera and/or rear camera may receive external multimedia data when the apparatus 400 is in an operating mode, such as a photographing mode or a video mode. Each front camera and rear camera may be a fixed optical lens system or have focal length and optical zooming capability.

The audio component 410 is configured to output and/or input audio signals. For example, the audio component 410 includes a microphone (MIC) that is configured to receive an external audio signal when the apparatus 400 is in an operating mode, such as a call mode, a recording mode, and a voice recognition mode. The received audio signal may be further stored in memory 404 or transmitted via communication component 416. In some examples, the audio component 410 also includes a speaker for outputting audio signals.

The I/O interface 412 provides an interface between the processing component 402 and a peripheral interface module. The above peripheral interface module may be a keyboard, a click wheel, buttons, or the like. These buttons may include but not limited to a home button, a volume button, a start button and a lock button.

The sensor component 414 includes one or more sensors to provide the apparatus 400 with status assessments in various aspects. For example, the sensor component 414 may detect an open/closed state of the apparatus 400 and a relative positioning of components such as the display and keypad of the apparatus 400, and the sensor component 414 can also detect a change in position of the apparatus 400 or a component of the apparatus 400, the presence or absence of user contact with the apparatus 400, orientation or acceleration/deceleration of the apparatus 400, and temperature change of the apparatus 400. The sensor component 414 may include a proximity sensor configured to detect the presence of a nearby object without any physical contact. The sensor component 414 may further include an optical sensor, such as a complementary metal-oxide-semiconductor (CMOS) or charged coupled device (CCD) image sensor which is used in imaging applications. In some examples, the sensor component 414 may also include an acceleration sensor, a gyro sensor, a magnetic sensor, a pressure sensor, or a temperature sensor.

The communication component 416 is configured to facilitate wired or wireless communication between the apparatus 400 and other devices. The apparatus 400 may access a wireless network based on a communication standard, such as Wi-Fi, 2G, 3G, 4G LTE, 5G NR, or a combination thereof. In an example, the communication component 416 receives broadcast signals or broadcast related information from an external broadcast management system via a broadcast channel. In an example, the communication component 416 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the apparatus 400 may be implemented by at least one application specific integrated circuit (ASIC), digital signal processor (DSP), digital signal processing device (DSPD), programmable logic device (PLD), field programmable gate array (FPGA), controller, microcontroller, microprocessor, or another electronic component for performing the above methods.

In one or more examples, there is also provided a non-transitory computer-readable storage medium including instructions, such as the memory 404 including instructions. These instructions may be executed by the one or more processors 420 of the apparatus 400 to complete the above methods. For example, the non-transitory computer-readable storage medium may be a read-only memory (ROM), a random access memory (RAM), a CD-ROM, a magnetic tape, a floppy disk, an optical data storage device, and the like.

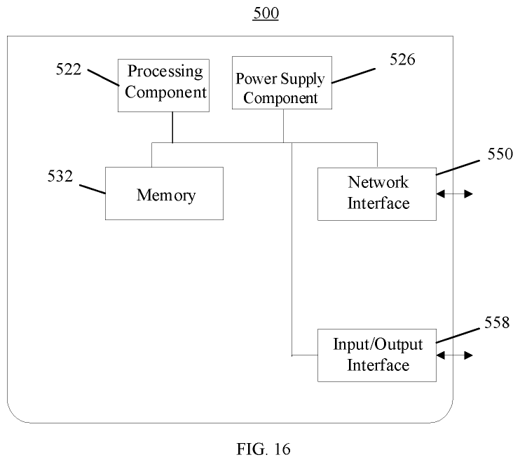

FIG. 16 illustrates a block diagram of an apparatus for AF session processing according to an example. For example, the apparatus 500 may be provided as a server. Referring to FIG. 16, the apparatus 500 includes a processing component 522 which further includes one or more processors, and a memory resource represented by a memory 532 which is used to store instructions that may be executed by the processing component 522, such as application programs. The application programs stored in the memory 532 may include one or more modules, each of which corresponds to a set of instructions. In addition, the processing component 522 is configured to execute the instructions to perform the above-mentioned methods.

The apparatus 500 may also include a power supply component 526 configured to perform power management of the apparatus 500, a wired or wireless network interface 550 configured to connect the apparatus 500 to a network, and an input/output (I/O) interface 558. The apparatus 500 may operate an operating system stored in the memory 532, which is based on Windows Server™, Mac OS X™, Unix™, Linux™, FreeBSD™ or the like.

The technical solutions provided by the examples of the present disclosure may achieve the following beneficial effects. According to the present disclosure, parameter information of a group of terminals can be sent via an update request for QoS of AF session(s), so as to perform a unified policy control on QoS update requirements of the whole group of terminals, thereby meeting the QoS update requirements of the multi-modal group of terminals.

It should be further understood that the term “plurality” in the present disclosure refers to two or more than two, and other quantifiers are similar. The term “and/or” describes the association relationships between associated objects, indicating that there can be three types of relationships. For example, A and/or B means that A exists alone, A and B exist at the same time, and B exists alone. The character “/” generally indicates that the associated objects before and after are in an “or” relationship. The singular forms “a”, “said” and “the” are also intended to include plurality, unless clearly indicated otherwise in the context.

It should be further understood that the terms “first”, “second”, etc. are used to describe various information, but such information should not be limited to these terms. These terms are only used to distinguish information of the same category with each other, without indicating a specific order or a important degree. In fact, the expressions such as “first” and “second” may be used interchangeably. For example, without departing from the scope of the present disclosure, first information may be referred as second information; and similarly, second information may also be referred as first information.

It should be further understood that although the being described in a specific order in the drawings, the operations in the examples of the present disclosure should not be understood as requiring these operations to be performed in the specific order shown or in a serial order, or requiring the operations to be completely performed as shown to get a desired result. In certain circumstances, multitasking and parallel processing may be advantageous.

Other implementations of the present disclosure will be readily apparent to those skilled in the art after implementing the disclosure by referring to the description. The present disclosure is intended to cover any variations, uses, or adaptations of the present disclosure that are in accordance with the general principles thereof and include common general knowledge or conventional technical means in the art that are not disclosed in the present disclosure. The specification and examples therein are only illustrative, and the scope and spirit of the present disclosure are to be indicated by appended claims.

It should be understood that the present disclosure is not limited to the above-described accurate structures illustrated in the drawings, and various modifications and changes can be made to the present disclosure without departing from the scope thereof. The scope of the present disclosure is to be limited only by the appended claims.

1. An application function (AF) session processing method, applied to a first network device, comprising:
sending an update request for quality of service (QoS) of an AF session,
wherein the update request for the QoS of the AF session comprises parameter information of a group of terminals, and
the group of terminals comprises one or more terminals.

2. The AF session processing method according to claim 1, wherein the parameter information of the group of terminals comprises at least one of:
an AF identifier;
a transaction reference identity;
a flow description mapped to the group of terminals;
a QoS reference mapped to the group of terminals; or
alternative service requirements.

3. An application function (AF) session processing method, applied to a second network device, comprising:
obtaining a first update request for quality of service (QoS) of an AF session,
wherein the first update request for the QoS of the AF session comprises parameter information of a group of terminals, and
the group of terminals comprises one or more terminals.

4. The AF session processing method according to claim 3, further comprising:
performing an authorization process for the first update request which is mapped to the group of terminals.

5. The AF session processing method according to claim 4, further comprising:
sending, in response to a successful authorization for the first update request, a second update request for application policy authorization,
wherein the second update request comprises the parameter information of the group of terminals.

6. The AF session processing method according to claim 5, further comprising:
receiving an update response for application policy authorization, the update response being mapped to the group of terminals.

7. The AF session processing method according to claim 3, wherein the parameter information of the group of terminals comprises at least one of:
an AF identifier;
a transaction reference identity;
a flow description mapped to the group of terminals;
a QoS reference mapped to the group of terminals; or
alternative service requirements.

8. An application function (AF) session processing method, applied to a third network device, comprising:
obtaining an update request for application policy authorization,
wherein the update request comprises parameter information of a group of terminals, and
the group of terminals comprises one or more terminals.

9. The AF session processing method according to claim 8, further comprising:
determining, in response to a successful authorization, a quality of service (QoS) parameter set mapped to the group of terminals.

10. The AF session processing method according to claim 9, wherein the update request comprises an alternative service request that comprises one or more QoS reference parameter sets mapped to the group of terminals.

11. The AF session processing method according to claim 10, further comprising:
determining, in response to the successful authorization, the QoS parameter set from the one or more QoS reference parameter sets.

12. The AF session processing method according to claim 8, further comprising:
sending an update response for application policy authorization, the update response being mapped to the group of terminals.

13. The AF session processing method according to claim 8, wherein the parameter information of the group of terminals comprises at least one of:
an AF identifier;
a transaction reference identity;
a flow description mapped to the group of terminals;
a QoS reference mapped to the group of terminals; or
alternative service requirements.

14-16. (canceled)

17. An application function (AF) session processing apparatus, comprising:
one or more processors; and
one or more memories for storing instructions executable by the one or more processors;
wherein the one or more processors are configured to perform the AF session processing method according to claim 1.

18. A non-transitory computer-readable storage medium, wherein instructions in the storage medium, when executed by one or more processors of a network device, make the network device be capable of performing the application session (AF) session processing method according to claim 1.

19. An application function (AF) session processing apparatus, comprising:
one or more processors; and
one or more memories for storing instructions executable by the one or more processors;
wherein the one or more processors are configured to perform the AF session processing method according to claim 3.

20. An application function (AF) session processing apparatus, comprising:
one or more processors; and
one or more memories for storing instructions executable by the one or more processors;
wherein the one or more processors are configured to perform the AF session processing method according to claim 8.

21. A non-transitory computer-readable storage medium, wherein instructions in the storage medium, when executed by one or more processors of a network device, make the network device be capable of performing the application session (AF) session processing method according to claim 3.

22. A non-transitory computer-readable storage medium, wherein instructions in the storage medium, when executed by one or more processors of a network device, make the network device be capable of performing the application session (AF) session processing method according to claim 8.
